(19) United States
(12) Patent Application Publication
(10) Pub. No.: US 2005/0079370 A1
(43) Pub. Date: Apr. 14, 2005

(54) Nano-multilayered structures, components and associated methods of manufacture

(76) Inventors: Reed Roeder Corderman, Niskayuna, NY (US); Pazhayannur Ramanathan Subramanian, Niskayuna, NY (US); Dheepa Srinivasan, Malleswaram (IN); Dennis Michael Gray, Delanson, NY (US); Krishnamurthy Anand, Bangalore (IN)

Correspondence Address: Christopher L. Bernard, Esq.;Christopher L. Bernard, PLLC, 511 West 8th Street #2B, Charlotte, NC, 28202, US

(21) Appl. No.: 10/684,061

(22) Filed: Oct. 10, 2003

(51) Int. Cl. B32B 15/04

(52) U.S. Cl. 428/469; 428/336; 427/596; 427/248.1; 427/569; 427/446; 204/192.15; 204/192.16

(57) ABSTRACT

Nano-multilayered structures, components and associated methods of manufacture suitable for use in high-temperature applications including a plurality of metallic alloy layers, wherein the thickness of each of the plurality of metallic alloy layers is on a nano scale, and a plurality of ceramic oxide layers disposed between the plurality of metallic alloy layers in an alternating manner, wherein the thickness of each of the plurality of ceramic oxide layers is on a nano scale.

### FIELD OF THE INVENTION

The present invention relates generally to nano-multilayered structures, components and associated methods of manufacture. More specifically, the present invention relates to nano-multilayered coating systems for use at elevated temperatures and associated methods for depositing the coating systems on components, such as gas turbine components, aircraft engine components and the like.

### BACKGROUND OF THE INVENTION

In many engineering applications, operating temperatures have increased in order to meet increasingly demanding performance and efficiency requirements. For example, the gas path temperatures in gas turbines, aircraft engines and the like have increased to well over about 1400° C. As a result, the components of these gas turbines, aircraft engines and the like are often exposed to temperatures exceeding about 1000° C. In order to withstand such elevated temperatures, the components are typically made of a high-temperature nickel, cobalt or iron-based superalloy. The components are also protected by an environmental or thermal-insulation coating, referred to as a thermal barrier coating.

Conventional high-temperature coating systems, such as MCrAlY and aluminides, however, have typically been developed for enhanced oxidation resistance, and not enhanced wear resistance, impact resistance, erosion resistance and clearance control. As a result, these coating systems do not retain their hardness and do not display adequate wear resistance, impact resistance, erosion resistance and clearance control at temperatures exceeding about 1000° C. The same is true of conventional thermal-sprayed coating systems, such as tungsten carbides and chromium carbides, and conventional phase-strengthened coating systems, such as Triballoy 800. Likewise, conventional ceramic thermal barrier coatings do not have the required toughness and do not display adequate wear resistance, impact resistance, erosion resistance and clearance control at temperatures exceeding about 1000° C.

Thus, what is needed is a coating system that provides enhanced wear resistance, impact resistance, erosion resistance and clearance control at temperatures exceeding about 1000° C. At such elevated temperatures, the coating system must retain its hardness, toughness and oxidation resistance. Finally, the coating system must be capable of being deposited on a component, such as a gas turbine component, an aircraft engine component or the like, using conventional deposition methods.

### BRIEF SUMMARY OF THE INVENTION

In various embodiments, the high-temperature nano-multilayered structures, components and associated methods of manufacture of the present invention utilize a plurality of alternating metallic alloy and ceramic oxide layers. These metallic alloy and ceramic oxide layers are selected such that they display adequate intrinsic oxidation resistance, especially above about 1000° C., and adhere to one another. The thickness of each of the metallic alloy and ceramic oxide layers is on a nano scale, resulting in a nano-multilayered coating system with a thickness that is on a micron scale. The number of metallic alloy and ceramic oxide layers utilized may vary, depending upon the thickness of each of the metallic alloy and ceramic oxide layers and the desired thickness of the nano-multilayered coating system. The thickness of the metallic alloy and ceramic oxide layers may be independently adjusted to control the hardness, strain tolerance and overall stability of the nano-multilayered coating system when subjected to thermo-mechanical stresses.

In one embodiment of the present invention, a nano-multilayered structure suitable for use in high-temperature applications includes a plurality of metallic alloy layers, wherein the thickness of each of the plurality of metallic alloy layers is on a nano scale, and a plurality of ceramic oxide layers disposed between the plurality of metallic alloy layers in an alternating manner, wherein the thickness of each of the plurality of ceramic oxide layers is on a nano scale.

In another embodiment of the present invention, a high-temperature component includes a substrate having a surface and a nano-multilayered structure disposed on the surface of the substrate. The nano-multilayered structure includes a plurality of metallic alloy layers, wherein the thickness of each of the plurality of metallic alloy layers is on a nano scale, and a plurality of ceramic oxide layers disposed between the plurality of metallic alloy layers in an alternating manner, wherein the thickness of each of the plurality of ceramic oxide layers is on a nano scale.

In a further embodiment of the present invention, a method for manufacturing a nano-multilayered structure suitable for use in high-temperature applications includes providing a substrate having a surface. The method also includes disposing a plurality of metallic alloy layers adjacent to the surface of the substrate, wherein the thickness of each of the plurality of metallic alloy layers is on a nano scale. The method further includes disposing a plurality of ceramic oxide layers adjacent to the surface of the substrate and between the plurality of metallic alloy layers in an alternating manner, wherein the thickness of each of the plurality of ceramic oxide layers is on a nano scale.

### BRIEF DESCRIPTION OF THE DRAWINGS

FIG. 1 is a cross-sectional side view of one embodiment of a high-temperature nano-multilayered structure of the present invention, including a plurality of metallic alloy and ceramic oxide layers disposed on the surface of a substrate; and

FIG. 2 is a flow chart of one embodiment of a method for manufacturing the high-temperature nano-multilayered structure of FIG. 1.

### DETAILED DESCRIPTION OF THE INVENTION

The high-temperature nano-multilayered structures, components and associated methods of manufacture of the present invention are based on the premise that a layered structure displays higher hardness and better wear resistance, impact resistance, erosion resistance and clearance control than would otherwise be predicted by the rule of mixtures. This is true because, when alternating layers of materials with different elastic moduli and crystal structures are brought together, the resistance to dislocation of the structure as a whole increases. This results from the plastic constraint experienced by dislocations when they are forced to travel in relatively narrow channels, image forces transmitted from one layer to another and the elastic modulus mismatch between adjacent layers. In other words, plastic flow in relatively ductile layers is constrained by more brittle layers and dislocation motion is restricted by pile-up mechanisms, image forces and elastic modulus mismatch effects. Cracks initiated within the more brittle layers are blunted by the relatively ductile layers and, under indentation conditions where the directions of principal tensile stresses change in orientation, cracks cannot travel along a fixed path as they are continuously deflected at layer boundaries.

Nano-multilayered coating systems have been developed for use in such applications as cutting tools and the like. The nano-multilayered coating systems typically include a plurality of nitride layers of alternating compositions, such as Ti—TiN, TiN—TiAlN, TiN—NbN, TiN—TaN or TiN—VN. The nitride layers each have a thickness of between about 0.1 nm and about 30 nm and are applied to a total thickness of about 0.5 microns to about 20 microns on a relatively hard substrate, such as hardened tool steel, cemented tungsten carbide cobalt or the like. Likewise, the nano-multilayered coating systems may include a plurality of metal nitrides, metal carbides and alumina (such as gamma alumina) and/or carbonitrides, forming a plurality of aperiodic layers, without regular spacing, or a structure with a continuously varying composition. The metal may include Ti, Nb, Hf, V, Ta, Mo, Zr, Cr, W, Al or a mixture thereof. The nitride-based nano-multilayered coating systems and the like, however, are unsuitable for use at temperatures above about 600° C. because they tend to oxidize. At their relatively low thicknesses, the nitride-based nano-multilayered coating systems and the like are also unsuitable for use with relatively soft substrates, such as copper, aluminum, copper alloys, aluminum alloys and the like, as the stress fields associated with contacting asperities may plastically deform the base material and cause the coating material to peel off.

In various embodiments, the high-temperature nano-multilayered structures, components and associated methods of manufacture of the present invention utilize a plurality of alternating metallic alloy and ceramic oxide layers. These metallic alloy and ceramic oxide layers are selected such that they display adequate intrinsic oxidation resistance, especially above about 1000° C., and adhere to one another. Preferably, the thickness of each of the metallic alloy and ceramic oxide layers is between about 3 nm and about 200 nm, resulting in a nano-multilayered coating system with a thickness of between about 3 microns and about 200 microns. The number of metallic alloy and ceramic oxide layers utilized may vary, depending upon the thickness of each of the metallic alloy and ceramic oxide layers and the desired thickness of the nano-multilayered coating system. The thickness of the metallic alloy and ceramic oxide layers may be independently adjusted to control the hardness, strain tolerance and overall stability of the nano-multilayered coating system when subjected to thermo-mechanical stresses.

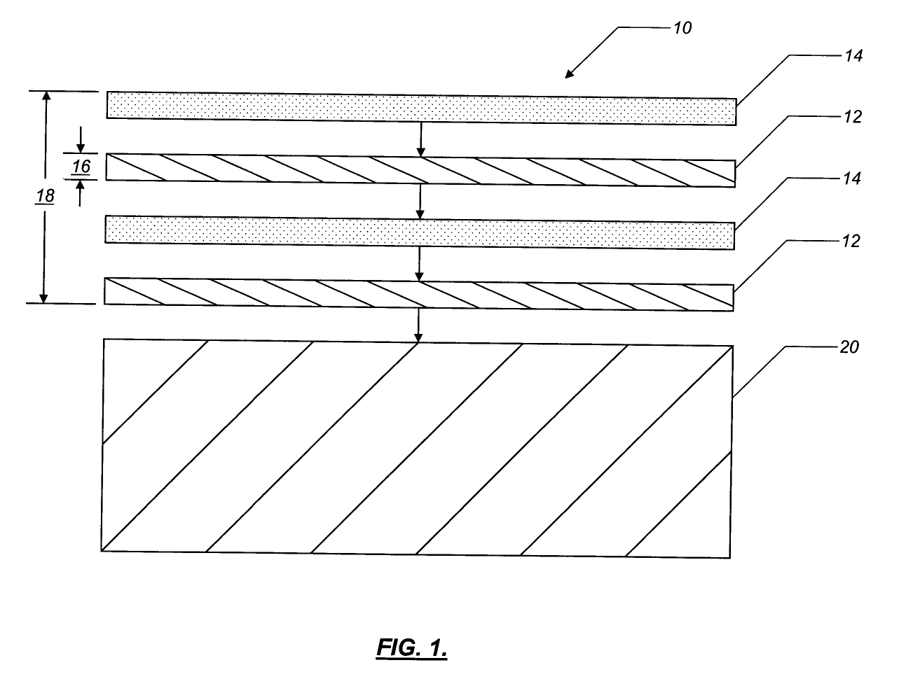

Referring to FIG. 1, in one embodiment of the present invention, the nano-multilayered structure consists of a nano-multilayered coating system 10 including a plurality of metallic alloy layers 12 disposed between a plurality of ceramic oxide layers 14 in an alternating manner. Preferably, the thickness 16 of each of the metallic alloy layers 12 and ceramic oxide layers 14 is between about 3 nm and about 200 nm, more preferably between about 10 nm and about 100 nm, resulting in a nano-multilayered coating system 10 with a thickness 18 of between about 3 microns and about 200 microns, more preferably of between about 5 microns and about 150 microns. The number of metallic alloy layers 12 and ceramic oxide layers 14 utilized may vary, depending upon the thickness 16 of each of the metallic alloy layers 12 and ceramic oxide layers 14 and the desired thickness 18 of the nano-multilayered coating system 10.

The plurality of metallic alloy layers 12 may each be made of, for example, nickel aluminide (NiAl), nickel aluminide doped with Hf (NiAl (Hf)), nickel aluminide doped with Zr (NiAl (Zr)), platinum aluminide (PtAl) or MCrAlY, where M is at least one of nickel, iron, cobalt and a combination thereof. The plurality of ceramic oxide layers 14 may each be made of, for example, alumina, yttria, zirconia, yttria-stabilized zirconia (YSZ), hafnia, a yttrium-based garnet, mullite or the like. Other suitable materials may, however, be used.

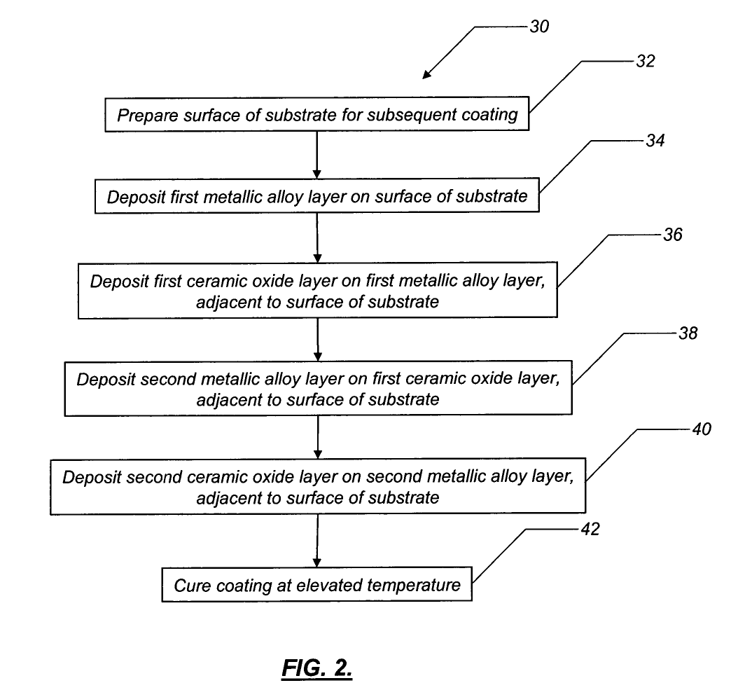

Referring to FIG. 2, in another embodiment of the present invention, a method 30 for manufacturing the nano-multilayered coating system 10 (FIG. 1) of the present invention includes preparing the surface of a substrate 20 (FIG. 1) for subsequent coating. (Block 32). For example, the surface of the substrate 20 may be prepared by grit blasting, polishing, chemical cleaning, ultrasonic washing, degreasing or a combination thereof. As described above, the substrate may include a high-temperature nickel, cobalt or iron-based superalloy or the like, such as that used to form a component of a gas turbine, an aircraft engine or the like. After the surface of the substrate 20 is prepared for subsequent coating, a first metallic alloy layer 12 (FIG. 1) is deposited on the surface of the substrate 20 using a physical or chemical vapor deposition method, such as, for example, chemical vapor deposition (CVD), plasma-enhanced chemical vapor deposition (PECVD), electron beam-physical vapor deposition, cathodic arc coating, sputtering, ion plasma coating or the like, well known to those of ordinary skill in the art. (Block 34). Alternatively, thermal spraying techniques, such as flame spraying, plasma spraying, high velocity oxygen fuel spraying and the like, also well known to those of ordinary skill in the art, may be used to deposit the first metallic alloy layer 12, as well as subsequent alloy layers. A first ceramic oxide layer 14 (FIG. 1) is then deposited on the first metallic alloy layer 12, adjacent to the surface of the substrate 20. (Block 36). A second metallic alloy layer 12 is then deposited on the first ceramic oxide layer 14, adjacent to the surface of the substrate 20, (Block 38), and a second ceramic oxide layer 14 is deposited on the second metallic alloy layer 12, adjacent to the surface of the substrate 20, (Block 40), and so on. Alternatively, a ceramic oxide layer 14 may be deposited on the surface of the substrate 20 prior to the deposition of any metallic alloy layer 12. In one embodiment, the first ceramic oxide layer 14, as well as subsequent ceramic oxide layers, is deposited using a physical or chemical vapor deposition method, such as, for example, chemical vapor deposition (CVD), plasma-enhanced chemical vapor deposition (PECVD), electron beam-physical vapor deposition, cathodic arc coating, sputtering, ion plasma coating or the like, well known to those of ordinary skill in the art. In another embodiment, thermal spraying techniques, such as flame spraying, plasma spraying, high velocity oxygen fuel spraying and the like, also well known to those of ordinary skill in the art, may be used to deposit the first ceramic oxide layer 14, as well as subsequent ceramic oxide layers. Finally, the nano-multilayered coating system 10 may be heat treated at an elevated temperature in a range of between about 600° C. and about 1400° C., or up to about 80% of the melting temperature of the nano-multilayered coating system 10. (Block 42). In one embodiment, the nano-multilayered coating system 10 is heat treated at a temperature of between about 600° C. and about 900° C.

The following example is included to provide additional guidance to those of ordinary skill in the art in practicing the invention, and is merely representative of the work that contributes to the teaching of the present invention. Accordingly, the example is not intended to limit the invention, as defined in the appended claims, in any manner.

For example, the two layered nanocomposites Cu—Mo and Ni20Cr—ZrO₂(7Y₂O₃) (also known in the art as yttria-stabilized zirconia, ZrO₂(7Y₂O₃), or 7YSZ) were produced by sputtering. A side sputtering system capable of depositing both conducting and insulating thin films, using either DC or RF potential, was used to produce both nano-multilayered thin film materials. In addition, the sputtering system may be used to clean the substrate in vacuo before thin film deposition.

In a typical experiment, glass slides, silica slides, silicon wafers and Cr-plated steel substrates are mounted onto a carrier plate, or pallet, mounted vertically inside the vacuum chamber of the sputtering system. The pallet can travel in a computer controlled sequence to either the vacuum load lock, the NiCr sputter target, the 7YSZ sputter target or the sputter etch area. The pallet with mounted substrates is first loaded into the vacuum chamber through the vacuum load lock and is immediately sent to the sputter etch area, where the stationary substrates are cleaned by Ar⁺ ion bombardment for 30 seconds at 0.8 kV potential and 10 mTorr Ar pressure. Second, the pallet then traverses the NiCr sputter target area at 50 cm/min, 2 kV potential and 12 mTorr Ar pressure to deposit 50 nm NiCr on the substrates. Third, the pallet traverses the 7YSZ sputter target area at 5 cm/min, 0.52 kW power and 15 mTorr Ar pressure to deposit 50 nm YSZ. The second and third steps then repeat 49 additional times to produce a nano-multilayered thin film with 50 layers of 50 nm Ni20Cr and 50 layers of 50 nm 7YSZ, for a total thickness of 5 micrometers. A similar procedure may be used to produce multilayered thin films with virtually any range of layer thicknesses, from about 1 nm to about 1000 nm, limited only by the time required to complete the individual and multiple sputtering steps.

Although the present invention has been illustrated and described with reference to preferred embodiments and examples thereof, it will be readily apparent to those of ordinary skill in the art that other embodiments and examples may perform similar functions and/or achieve similar results. All such equivalent embodiments and examples are within the spirit and scope of the present invention and are intended to be covered by the following claims.

1. A nano-multilayered structure suitable for use in high-temperature applications, comprising:
a plurality of metallic alloy layers, wherein the thickness of each of the plurality of metallic alloy layers is on a nano scale; and
a plurality of ceramic oxide layers disposed between the plurality of metallic alloy layers in an alternating manner, wherein the thickness of each of the plurality of ceramic oxide layers is on a nano scale.

2. The structure of claim 1, wherein each of the plurality of metallic alloy layers comprises a material selected from the group consisting of nickel aluminide, nickel aluminide doped with Hf, nickel aluminide doped with Zr, platinum aluminide and an MCrAlY alloy, wherein M comprises at least one of nickel, cobalt, iron and a combination thereof.

3. The structure of claim 1, wherein each of the plurality of ceramic oxide layers comprises at least one material selected from the group consisting of alumina, yttria, zirconia, yttria-stabilized zirconia, hafnia, a yttrium-based garnet and mullite.

4. The structure of claim 1, wherein the thickness of each of the plurality of metallic alloy layers and each of the plurality of ceramic oxide layers is between about 3 nm and about 200 nm.

5. The structure of claim 4, wherein the thickness of each of the plurality of metallic alloy layers and each of the plurality of ceramic oxide layers is between about 10 nm and about 100 nm.

6. The structure of claim 1, wherein the collective thickness of the plurality of metallic alloy layers and the plurality of ceramic oxide layers is between about 3 microns and about 200 microns.

7. The structure of claim 6, wherein the collective thickness of the plurality of metallic alloy layers and the plurality of ceramic oxide layers is between about 5 microns and about 150 microns.

8. The structure of claim 1, wherein the nano-multilayered structure comprises a nano-multilayered coating system.

9. The structure of claim 1, further comprising a substrate having a surface, wherein the plurality of metallic alloy layers and the plurality of ceramic oxide layers are disposed on the surface of the substrate.

10. The structure of claim 9, wherein the substrate comprises at least one of a nickel-based superalloy, a cobalt-based superalloy, an iron-based superalloy, and an MCrAlY alloy, wherein M comprises at least one of nickel, cobalt, iron and a combination thereof.

11. The structure of claim 9, wherein the substrate comprises a component of a gas turbine or an aircraft engine.

12. A high-temperature component, comprising:
a substrate having a surface; and
a nano-multilayered structure disposed on the surface of the substrate, the nano-multilayered structure comprising:
a plurality of metallic alloy layers, wherein the thickness of each of the plurality of metallic alloy layers is on a nano scale; and
a plurality of ceramic oxide layers disposed between the plurality of metallic alloy layers in an alternating manner, wherein the thickness of each of the plurality of ceramic oxide layers is on a nano scale.

13. The component of claim 12, wherein each of the plurality of metallic alloy layers comprises a material selected from the group consisting of nickel aluminide, nickel aluminide doped with Hf, nickel aluminide doped with Zr, platinum aluminide and an MCrAlY alloy, wherein M comprises at least one of nickel, cobalt, iron and a combination thereof.

14. The component of claim 12, wherein each of the plurality of ceramic oxide layers comprises at least one material selected from the group consisting of alumina, yttria, zirconia, yttria-stabilized zirconia, hafnia, a yttrium-based garnet and mullite.

15. The component of claim 12, wherein the thickness of each of the plurality of metallic alloy layers and each of the plurality of ceramic oxide layers is between about 3 nm and about 200 nm.

16. The component of claim 15, wherein the thickness of each of the plurality of metallic alloy layers and each of the plurality of ceramic oxide layers is between about 10 nm and about 100 nm.

17. The component of claim 12, wherein the thickness of the nano-multilayered structure is between about 3 microns and about 200 microns.

18. The component of claim 17, wherein the thickness of the nano-multilayered structure is between about 5 microns and about 150 microns.

19. The component of claim 12, wherein the nano-multilayered structure comprises a nano-multilayered coating system.

20. The component of claim 12, wherein the high-temperature component comprises a component of a gas turbine or an aircraft engine.

21. The component of claim 12, wherein the substrate comprises at least one of a nickel-based superalloy, a cobalt-based superalloy, an iron-based superalloy, and an MCrAlY alloy, wherein M comprises at least one of nickel, cobalt, iron and a combination thereof.

22. A method for manufacturing a nano-multilayered structure suitable for use in high-temperature applications, comprising:
providing a substrate having a surface;
disposing a plurality of metallic alloy layers adjacent to the surface of the substrate, wherein the thickness of each of the plurality of metallic alloy layers is on a nano scale; and
disposing a plurality of ceramic oxide layers adjacent to the surface of the substrate and between the plurality of metallic alloy layers in an alternating manner, wherein the thickness of each of the plurality of ceramic oxide layers is on a nano scale.

23. The method of claim 22, wherein each of the plurality of metallic alloy layers comprises a material selected from the group consisting of nickel aluminide, nickel aluminide doped with Hf, nickel aluminide doped with Zr, platinum aluminide and an MCrAlY alloy, wherein M comprises at least one of nickel, cobalt, iron and a combination thereof.

24. The method of claim 22, wherein each of the plurality of ceramic oxide layers comprises at least one material selected from the group consisting of alumina, yttria, zirconia, yttria-stabilized zirconia, hafnia, a yttrium-based garnet and mullite.

25. The method of claim 22, wherein the thickness of each of the plurality of metallic alloy layers and each of the plurality of ceramic oxide layers is between about 3 nm and about 200 nm.

26. The method of claim 25, wherein the thickness of each of the plurality of metallic alloy layers and each of the plurality of ceramic oxide layers is between about 10 nm and about 100 nm.

27. The method of claim 22, wherein the collective thickness of the plurality of metallic alloy layers and the plurality of ceramic oxide layers is between about 5 microns and about 150 microns.

28. The method of claim 27, wherein the collective thickness of the plurality of metallic alloy layers and the plurality of ceramic oxide layers is between about 5 microns and about 150 microns.

29. The method of claim 22, wherein the nano-multilayered structure comprises a nano-multilayered coating system.

30. The method of claim 22, wherein the substrate comprises a component of a gas turbine or an aircraft engine.

31. The method of claim 22, wherein disposing the plurality of metallic alloy layers adjacent to the surface of the substrate comprises depositing the plurality of metallic alloy layers adjacent to the surface of the substrate using a physical vapor deposition technique.

32. The method of claim 31, wherein the physical vapor deposition technique comprises a technique selected from the group consisting of electron beam-physical vapor deposition, cathodic arc coating, ion plasma coating and sputtering.

33. The method of claim 22, wherein disposing the plurality of metallic alloy layers adjacent to the surface of the substrate comprises depositing the plurality of metallic alloy layers adjacent to the surface of the substrate using a thermal sparying technique.

34. The method of claim 33, wherein the thermal spraying technique comprises a technique selected from the group consisting of flame spraying, plasma spraying and high velocity oxygen fuel spraying.

35. The method of claim 22, wherein disposing the plurality of metallic alloy layers adjacent to the surface of the substrate comprises depositing the plurality of metallic alloy layers adjacent to the surface of the substrate using a chemical vapor deposition technique.

36. The method of claim 22, wherein disposing the plurality of ceramic oxide layers adjacent to the surface of the substrate and between the plurality of metallic alloy layers in an alternating manner comprises disposing the plurality of ceramic oxide layers adjacent to the surface of the substrate and between the plurality of metallic alloy layers in an alternating manner using a physical vapor deposition technique.

37. The method of claim 36, wherein the physical vapor deposition technique comprises a technique selected from the group consisting of electron beam-physical vapor deposition, cathodic arc coating, ion plasma coating and sputtering.

38. The method of claim 22, wherein disposing the plurality of ceramic oxide layers adjacent to the surface of the substrate and between the plurality of metallic alloy layers in an alternating manner comprises disposing the plurality of ceramic oxide layers adjacent to the surface of the substrate and between the plurality of metallic alloy layers in an alternating manner using a thermal spraying technique.

39. The method of claim 38, wherein the thermal spraying technique comprises a technique selected from the group consisting of flame spraying, plasma spraying and high velocity oxygen fuel spraying.

40. The method of claim 22, wherein disposing the plurality of ceramic oxide layers adjacent to the surface of the substrate and between the plurality of metallic alloy layers in an alternating manner comprises disposing the plurality of ceramic oxide layers adjacent to the surface of the substrate and between the plurality of metallic alloy layers in an alternating manner using a chemical vapor deposition technique.

41. The method of claim 22, wherein the substrate comprises at least one of a nickel-based superalloy, a cobalt-based superalloy, an iron-based superalloy, and an MCrAlY alloy, wherein M comprises at least one of nickel, cobalt, iron and a combination thereof.

42. The method of claim 22, further comprising the step of heat treating the nano-multilayered structure at a predetermined temperature.

43. The method of claim 42, wherein the predetermined temperature is in a range of between about 600° C. to about 1400° C.

44. The method of claim 43, wherein the predetermined temperature is in a range of between about 600° C. to about 1400° C.

45. The method of claim 42, wherein the step of heat treating the nano-multilayered structure at a predetermined temperature comprises heat treating the nano-multilayered structure at a temperature of up to about 80% of the melting temperature of the nano-multilayered structure.
